(19) United States
(12) Patent Application Publication
(10) Pub. No.: US 2012/0173408 A1
(43) Pub. Date: Jul. 5, 2012

(54) Donor Locking Rail

(75) Inventors: Robert J. Theis, JR., Manlius, NY (US); Michael S. Murphy, Baldwinsville, NY (US)

(73) Assignee: J. R. CLANCY, INC., Syracuse, NY (US)

(21) Appl. No.: 12/980,600

(22) Filed: Dec. 29, 2010

(51) Int. Cl. G06Q 40/00; G09F 1/02; H04N 5/64; F16M 13/00

(52) U.S. Cl. 705/39; 248/309.1; 40/124.06; 348/836; 348/E05.128

(57) ABSTRACT

A system and/or method for recognizing a theatre donation by placing a notice on a locking rail sub-system in a theatre. This system and/or method is believed to be rather counterintuitive because the locking rail is generally a low visibility part of the theatre, where the general public does not traditionally go. Despite this low visibility, the present invention is believed to foster a surprisingly large amount of goodwill, the relatively low visibility of the locking rail assembly notwithstanding. Also, because the locking rail is such a critical piece of equipment for safety purposes, the present invention recognizes that the good associations with donors and/or donations will tend to be subtly and psychologically enhanced by the fact that the donation related information is placed on the locking rail assembly. Also disclosed is a video display (for example, an LCD video display) that is mechanically connected to the rail of a locking rail assembly, and is used to convey information relating to the locking rail assembly.

### BACKGROUND OF THE INVENTION

1. Field of the Invention

The present invention relates to theatre equipment and more particularly to locking rails (see DEFINITIONS section) for use with theatre rigging sub-systems (see DEFINITIONS section).

2. Description of the Related Art

A conventional theatre has many sub-systems, such as a building structure sub-system, a seating sub-system, a ventilation, heating and cooling sub-system, a stage and orchestra pit sub-system, and a rigging sub-system. The rigging sub-system includes flexible lines (such as cables or ropes) for moving theatre-related objects (like scenery battens and moveable lighting fixtures). One example of a rigging sub-system, or a part of a rigging sub-system is know as a counterweight arbor fly system. It is conventional for a theatre rigging system to include a locking rail assembly (see DEFINITIONS section).

It is conventional for the seating-sub-system of theatres to include plaques indicating donors and/or donations on the seats of the theatre. For example, the article “Tivoli Theatre Plans Open House” (dated 16 Sep. 2008 and published at http://www.chattanooga.gov/General_Government/62_TivoliTheatrePlansOpenHouse.htm) discloses that brass memorial plaques permanently attached to the backs of theatre seats. It makes intuitive sense to attach donor plaques to the back of theatre seats because the general public, and especially the segment of the general public that appreciates the art of the theatre, will be likely to see the name on the seats and will form positive associations with the donor out of natural gratitude for the donor's donation.

The following published documents may also include helpful background information: (i) U.S. Pat. No. 2,098,568 (“Cone”); (ii) U.S. Pat. No. 1,120,723 (“Kyle”).

Description Of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, may not reflect subject matter developed early enough in time and/or may not be sufficiently enabling so as to amount to prior art for patent law purposes. To the extent that specific publications are discussed above in this Description of the Related Art Section, they are all hereby incorporated by reference into this document in their respective entirety(ies).

### BRIEF SUMMARY OF THE INVENTION

The present invention is directed to a system and/or method for recognizing a theatre donation by placing a notice on a locking rail sub-system in a theatre. This system and/or method is believed to be rather counterintuitive because the locking rail is generally a low visibility part of the theatre, where the general public does not traditionally go. Despite this low visibility, the present invention is believed to foster a surprisingly large amount of goodwill, the relatively low visibility of the locking rail assembly notwithstanding. Also, because the locking rail is such a critical piece of equipment for safety purposes, the present invention recognizes that the good associations with donors and/or donations will tend to be subtly and psychologically enhanced by the fact that the donation related information is placed on the locking rail assembly.

According to an aspect of the present invention, the locking rail assembly includes a rail member; a plurality of locking sub-assemblies; and a first donation-related display sub-assembly. Each locking sub-assembly of the plurality of locking sub-assemblies is mechanically connected to the rail member. Each locking sub-assembly of the plurality of locking sub-assemblies is sized, shaped, located and/or connected to selectively lock a load bearing line. The first donation-related display is structured and/or located to display information related to a charitable donation. The first donation-related display is mechanically connected to the rail member.

According to a further aspect of the present invention, a method of operating a theatre includes the following steps (not necessarily in the following order): accepting a charitable donation to be used to further the interests of the theatre; installing a locking rail assembly in the theatre; and mechanically connecting to the locking rail assembly a first donation-related display, with the first-donation related display being structured and/or located to display information related to the charitable donation.

According to a further aspect of the present invention, a locking rail assembly includes: a rail member; a plurality of locking sub-assemblies; a first video display; and a computer system. Each locking sub-assembly of the plurality of locking sub-assemblies is mechanically connected to the rail member. Each locking sub-assembly of the plurality of locking sub-assemblies is sized, shaped, located and/or connected to selectively lock a load bearing line. The first video display is structured and/or located to display information related to the locking rail assembly. The computer system is in data communication connection with the first video display. The computer system is structured, programmed, located and/or connected to generate at least a first informational display on the first video display, with the first informational display including information relating to the locking rail assembly.

### BRIEF DESCRIPTION OF THE DRAWINGS

The present invention will be more fully understood and appreciated by reading the following Detailed Description in conjunction with the accompanying drawings, in which:

FIG. 1 is a perspective view of a first embodiment of a locking rail assembly according to the present invention; and

FIG. 2 is a front view of a display panel of the first embodiment assembly; and

FIG. 3 is a second embodiment of a locking rail assembly according to the present invention.

### DETAILED DESCRIPTION OF THE INVENTION

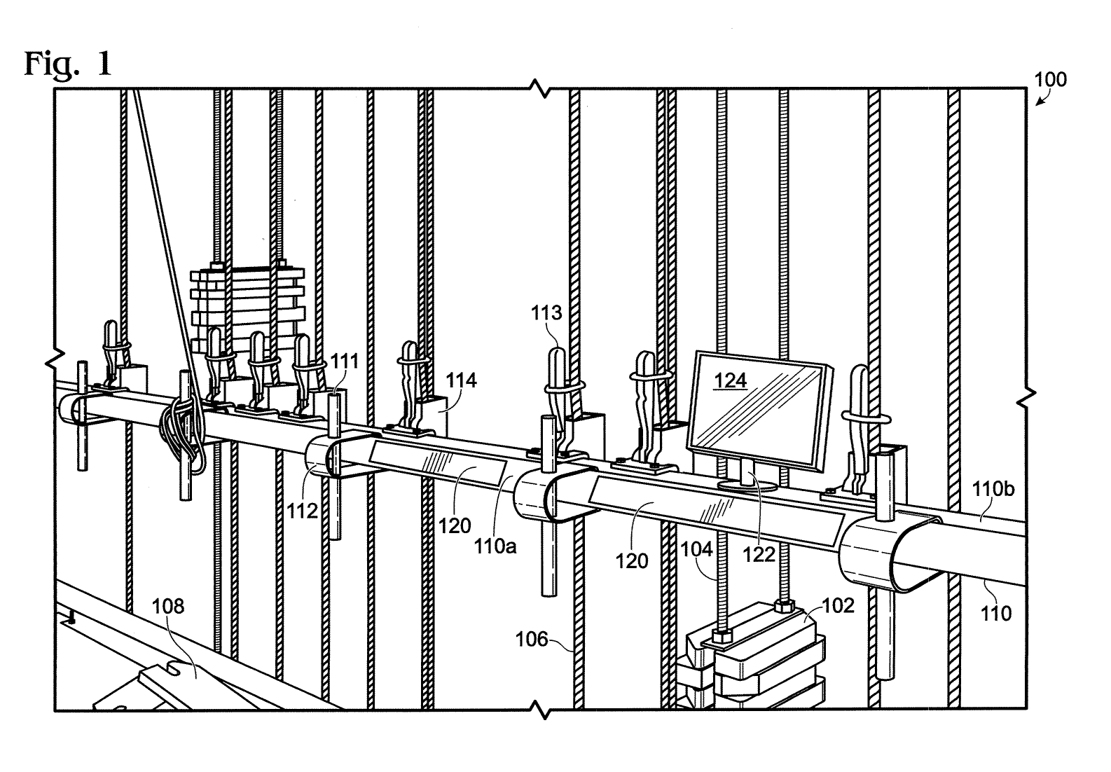

FIGS. 1 show locking rail assembly 100, including: stacked counterweights 102; counterweight stack guide hardware sub-assembly 104; ropes 106; loose counterweights 108; rail member 110 (including outwards facing surface 110a and upwards facing surface 110b); stationary handles 111; stationary handle brackets 112; movable handles 113; line locking sub-assemblies 114; outwards facing donation-related cards 120; video display bracket 122; and video display screen 124.

Outwards facing donor cards 120 are any sort of relatively permanent cards that can be printed with donation-related information (see DEFINITIONS section), such as metal plaques or plastic nameplate type displays. Because the cards are relatively permanent, they cannot take forms that are unlikely to remain intact over time. For example, cards 120 are not merely pieces of paper taped onto the rail with cellophane tape. Preferably, mounting of the cards 120 should be relatively permanent, such as by glue or screws. However, some embodiments of the present invention may employ card-attaching hardware that allows a detachably attachable connection between the card and the rail, such as a bracket with a slot to firmly hold the card in a detachably attachable manner, or strong magnets. The donation-related information may be printed by any technique (now known or to be developed in the future). the printing is preferably relatively permanent, such as engraving, embossing, ink printing, printing with paint and so on. However, in some embodiments the printing may be transient, such as a donation-related card in the form of a video display on an LCD panel. Although cards 120 are mechanically connected to an outwards facing surface of the rail member, in other embodiments of the present invention, the cards can be put anywhere on the locking rail assembly, so long as they do not interfere with operation of the larger theatre rigging sub-system of which locking rail assembly 100 is a part.

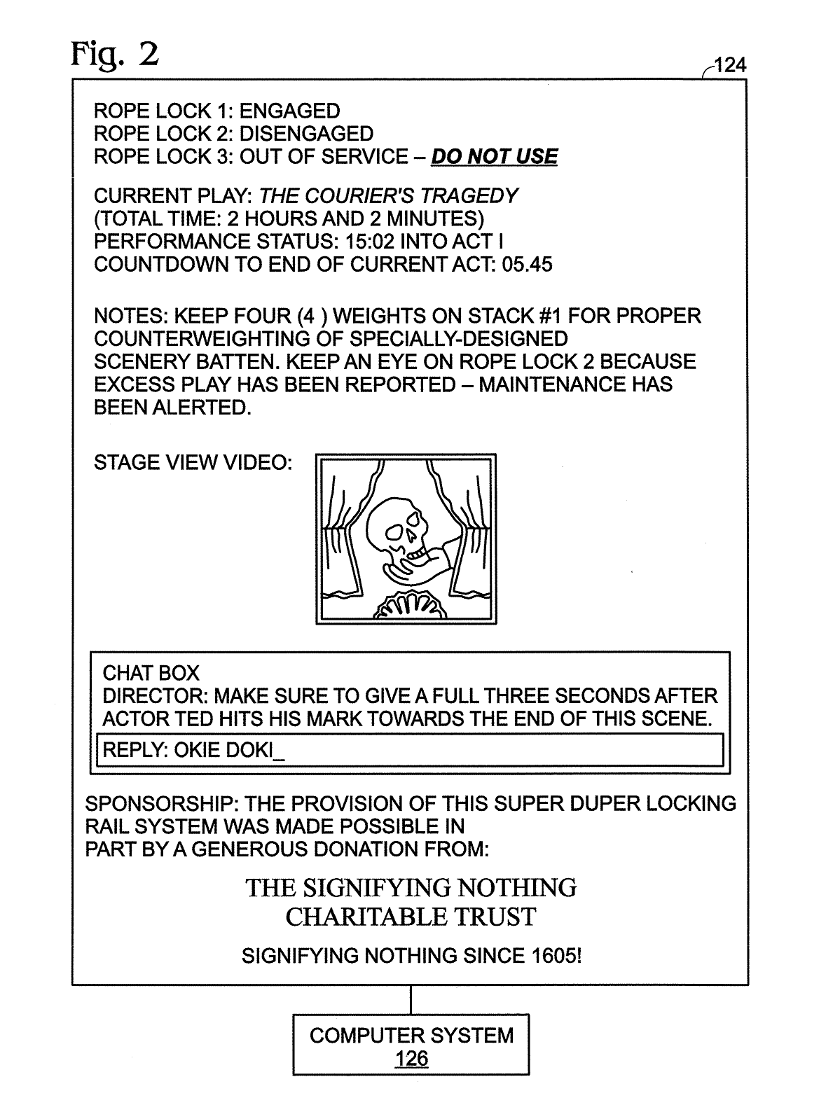

FIG. 2 shows an exemplary video display 124 and computer system 126. System 126 is in data communication (see DEFINITIONS section) with the video display and provides either a video signal, or data that can be used to construct a video signal, to it. As shown in FIG. 2, the video display may have many types of information relating to the locking rail assembly, including, but not necessarily limited to: (i) information about status of the locking sub-assemblies; (ii) information about the performance that the locking rail assembly is helping to accomplish; (iii) information about locking rail maintenance and/or operation; (iv) video helpful in operation of the locking rail (for example remote views of the theatre, instructional videos); (v) communication (for example, email, instant messaging); and/or (vi) donation-related information. Because video displays are dynamic, much more information can be presented to those who operate the locking rail, and those who happen to come into the proximity of the rail. While FIG. 1 shows display 124 as being mechanically connected to rail 110 through bracket 122, the video display may be connected to the rail in other ways, such as by being mounted directly to the rail member by screws or the like.

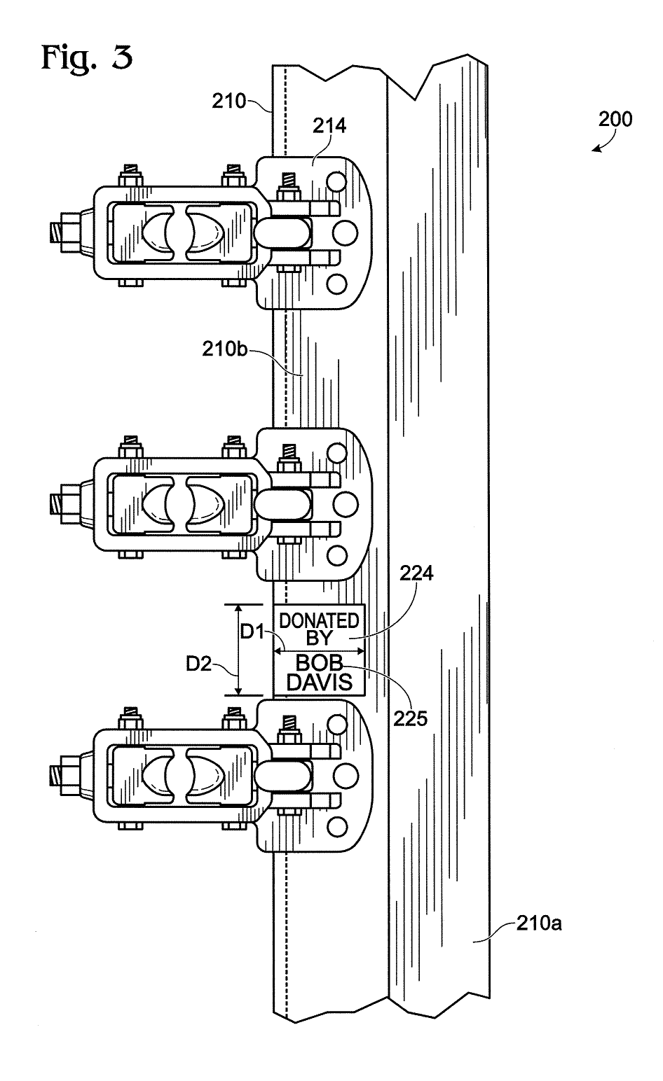

FIG. 3 shows preferred locking rail assembly 200 according to the present invention, including: locking rail 210 (including outwards facing surface 210a and upwards facing surface 210b); locking sub-assemblies 214; and upwards facing donation-related card 224 (including donation-related information 225). The upwards facing donation-related card is considered as a preferred embodiment of the present invention because it is considered especially aesthetically pleasing. Some preferred, exemplary dimensions, as shown in FIG. 3 are: (i) D1=2.0 inches; and (ii) D2=2.0 inches. It is further noted that card 224 is in proximity to the locking assembly and its movable handle, which is believed to enhance the appeal of the card and the goodwill generated by the card.

### DEFINITIONS

Any and all published documents mentioned herein shall be considered to be incorporated by reference, in their respective entireties, herein to the fullest extent of the patent law. The following definitions are provided for claim construction purposes:

Present invention: means at least some embodiments of the present invention; references to various feature(s) of the “present invention” throughout this document do not mean that all claimed embodiments or methods include the referenced feature(s).

Embodiment: a machine, manufacture, system, method, process and/or composition that may (not must) meet the embodiment of a present, past or future patent claim based on this patent document; for example, an “embodiment” might not be covered by any claims filed with this patent document, but described as an “embodiment” to show the scope of the invention and indicate that it might (or might not) covered in a later arising claim (for example, an amended claim, a continuation application claim, a divisional application claim, a reissue application claim, a re-examination proceeding claim, an interference count); also, an embodiment that is indeed covered by claims filed with this patent document might cease to be covered by claim amendments made during prosecution.

First, second, third, etc. (“ordinals”): Unless otherwise noted, ordinals only serve to distinguish or identify (e.g., various members of a group); the mere use of ordinals shall not be taken to necessarily imply order (for example, time order, space order).

Electrically Connected: means either directly electrically connected, or indirectly electrically connected, such that intervening elements are present; in an indirect electrical connection, the intervening elements may include inductors and/or transformers.

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, quick-release connections, latches and/or magnetic connections), force fit connections, friction fit connections, connections secured by engagement caused by gravitational forces, pivoting or rotatable connections, and/or slidable mechanical connections.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (ii) in a single proximity within a larger piece of software code; (iii) located within a single piece of software code; (iv) located in a single storage device, memory or medium; (v) mechanically connected; (vi) electrically connected; and/or (vii) connected in data communication.

locking rail: any locking rail for locking theatrical ropes, chains and/or cables, regardless of the specific locking mechanism(s) use or how many locking mechanisms are present on the rail.

theatre rigging sub-systems: any subsystem for moving theatrical objects (for example, battens, lights, scenery) in any indoor or outdoor theatre structure.

donation-related information: any information related to a theatre donation, regardless of whether the donation is tax-deductible and/or made for charitable reasons.

To the extent that the definitions provided above are consistent with ordinary, plain, and accustomed meanings (as generally shown by documents such as dictionaries and/or technical lexicons), the above definitions shall be considered supplemental in nature. To the extent that the definitions provided above are inconsistent with ordinary, plain, and accustomed meanings (as generally shown by documents such as dictionaries and/or technical lexicons), the above definitions shall control.

Unless otherwise explicitly provided in the claim language, steps in method steps or process claims need only be performed in the same time order as the order the steps are recited in the claim only to the extent that impossibility or extreme feasibility problems dictate that the recited step order be used. This broad interpretation with respect to step order is to be used regardless of whether the alternative time ordering(s) of the claimed steps is particularly mentioned or discussed in this document—in other words, any step order discussed in the above specification shall be considered as required by a method claim only if the step order is explicitly set forth in the words of the method claim itself. Also, if some time ordering is explicitly set forth in a method claim, the time ordering claim language shall not be taken as an implicit limitation on whether claimed steps are immediately consecutive in time, or as an implicit limitation against intervening steps.

What is claimed is:

1. A locking rail assembly comprising:
a rail member;
a plurality of locking sub-assemblies; and
a first donation-related display sub-assembly;
wherein:
each locking sub-assembly of the plurality of locking sub-assemblies is mechanically connected to the rail member;
each locking sub-assembly of the plurality of locking sub-assemblies is sized, shaped, located and/or connected to selectively lock a load bearing line;
the first donation-related display is structured and/or located to display information related to a charitable donation; and
the first donation-related display is mechanically connected to the rail member.

2. The assembly of claim 1 wherein:
the first donation-related card is made of a flat durable material; and
the information related to the charitable donation is printed in a relatively permanent manner on a major surface of the first donation-related card.

3. The assembly of claim 1 wherein:
the rail member is designed to be placed in a theatre in a horizontal orientation; and
the lift assemblies are designed to lock load bearing lines that are in a vertical orientation.

4. The assembly of claim 1 wherein the donation related information includes the identity of an entity that has made a donation to a theatre in which the locking rail assembly is installed.

5. The assembly of claim 1 wherein:
the rail member includes an upwards facing surface; and
the first donation-related display is mechanically connected directly to the upwards facing surface of the rail member so that the display of information related to a charitable donation faces upwards.

6. The assembly of claim 1 further comprising a plurality of moveable handles, wherein each movable handle respectively operates one locking sub-assembly of the plurality of locking sub-assemblies.

7. The assembly of claim 6 wherein:
the first donation-related display is one of a plurality of donation-related displays; and
each donation-related display is mechanically connected to the locking rail assembly in proximity to a moveable handle of the plurality of moveable handles.

8. A method of operating a theatre comprising the following steps (not necessarily in the following order):
accepting a charitable donation to be used to further the interests of the theatre;
installing a locking rail assembly in the theatre; and
mechanically connecting to the locking rail assembly a first donation-related display, with the first-donation related display being structured and/or located to display information related to the charitable donation.

9. A locking rail assembly comprising:
a rail member;
a plurality of locking sub-assemblies;
a first video display; and
a computer system;
wherein:
each locking sub-assembly of the plurality of locking sub-assemblies is mechanically connected to the rail member;
each locking sub-assembly of the plurality of locking sub-assemblies is sized, shaped, located and/or connected to selectively lock a load bearing line;
the first video display is structured and/or located to display information related to the locking rail assembly;
the computer system is in data communication connection with the first video display; and
the computer system is structured, programmed, located and/or connected to generate at least a first informational display on the first video display, with the first informational display including information relating to the locking rail assembly.
